(19) United States
(12) Patent Application Publication
(10) Pub. No.: US 2025/0310246 A1
(43) Pub. Date: Oct. 2, 2025

(54) MESSAGE PROCESSING SYSTEM AND METHOD, DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Guochun HONG, Hangzhou, Zhejiang (CN); Lei SHI, Beijing (CN); Shuguo ZHUO, Hangzhou, Zhejiang (CN); Yidong YAO, Hangzhou, Zhejiang (CN)

(21) Appl. No.: 18/864,269

(22) PCT Filed: Nov. 28, 2022
(86) PCT No.: PCT/CN2022/134827

§ 371 Date: Nov. 8, 2024

(30) Foreign Application Priority Data
May 17, 2022 (CN) 202210540808.3

(51) Int. Cl. H04L 45/00; H04L 45/74

(52) U.S. Cl. CPC H04L 45/54; H04L 45/74

(57) ABSTRACT

Embodiments of the present application provide a message processing system and method, a device, and a storage medium. The method includes: a user plane function network element firstly acquires a first forwarding table and determines from it a correspondence between a message generator and a message processing manner to generate a second forwarding table, and then sends the second forwarding table to a message forwarding tool in a system. The message forwarding tool processes a message generated by the message generator according to the message processing manner obtained by query in the second forwarding table. In the above process, the data quantity of the second forwarding table is less than that of the first forwarding table. Therefore, the message forwarding tool consumes less CPU resources in the process of making the query in the second forwarding table and processing the message, ensuring message forwarding efficiency. In addition, the generation of the forwarding table and the query in the forwarding table are respectively completed by the user plane function network element and the message forwarding tool in the message forwarding system, that is, decoupling of the generation of the forwarding table and the query in the forwarding table is realized, which can avoid the situation that a message cannot be processed due to a failure of the user plane function network element.

### CROSS-REFERENCE TO RELATED APPLICATION

This application is a National Stage of International Application No. PCT/CN2022/134827, filed on Nov. 28, 2022, which claims priority to Chinese patent application No. 202210540808.3, filed with the China National Intellectual Property Administration on May 17, 2022 and entitled “MESSAGE PROCESSING SYSTEM AND METHOD, DEVICE, AND STORAGE MEDIUM”. These applications are hereby incorporated by reference in their entireties.

### TECHNICAL FIELD

The present application relates to the field of communication technology and, in particular, to a message processing system and method, a device, and a storage medium.

### BACKGROUND

With the continuous development of the fifth generation mobile communication technology (abbreviated as “5G”), 5G communication systems have been applied to various fields. For example, for different applications (abbreviated as “APPs”) on a terminal device that can provide different services for a user, a better service experience can be provided to the user with the help of a 5G communication system. For another example, vehicles, road side units and a 5G communication system may form Internet of Vehicles, and a better self-driving experience can be provided to a driver with the help of the Internet of Vehicles. For another example, a 5G communication system may also be applied to the industrial field.

Following the foregoing examples, when the user uses the services provided by the APPs or the self-driving service, service quality is positively correlated with forwarding efficiency of messages generated in a service providing process. Therefore, how to improve the forwarding efficiency of messages becomes an urgent problem to be solved.

### SUMMARY

In view of this, embodiments of the present application provide a message processing system and method, a device, and a storage medium, for improving message forwarding efficiency.

In a first aspect, an embodiment of the present application provides a message processing system, including: a first user plane function network element and a message forwarding tool of a Core Network;
the first user plane function network element is configured to: acquire a first forwarding table; determine, from the first forwarding table, a correspondence between a message generator and a message processing manner, to generate a second forwarding table; send the second forwarding table to the message forwarding tool; the message forwarding tool is configured to: receive a to-be-processed message sent by the message generator; process the to-be-processed message according to the second forwarding table.

In a second aspect, an embodiment of the present application provides a message processing method, applied to a first user plane function network element in a message processing system, where the method includes:
acquiring a first forwarding table; determining, from the first forwarding table, a correspondence between a message generator and a message processing manner, to generate a second forwarding table; sending the second forwarding table to a message forwarding tool in the message processing system, to enable the message forwarding tool to process a to-be-processed message generated by the message generator according to the second forwarding table.

In a third aspect, an embodiment of the present application provides a message processing method, applied to a user plane function network element of a Core Network, where the method includes:
acquiring a first forwarding table; determining, from the first forwarding table, a correspondence between a message generator and a message processing manner, to generate a second forwarding table; processing, according to the second forwarding table, a to-be-processed message generated by the message generator.

In a fourth aspect, an embodiment of the present application provides an electronic device, including a processor and a memory, where the memory is configured to store one or more computer instructions, and when the one or more computer instructions are executed by the processor, the message processing method in the above second aspect or third aspect is implemented. The electronic device may further include a communication interface for communicating with other devices or a communication network.

In a fifth aspect, an embodiment of the present application provides a non-transitory machine-readable storage medium, where the non-transitory machine-readable storage medium stores executable code, and when the executable code is executed by a processor of an electronic device, the processor is at least enabled to implement the message processing method according to the second aspect or third aspect.

In the message processing system provided in the embodiments of the present application, firstly the first user plane function network element in the message processing system acquires the first forwarding table, and determines from it the correspondence between the message generator and the message processing manner, to generate the second forwarding table. Then the first user plane function network element sends the second forwarding table to the message forwarding tool in the message processing system. After receiving the to-be-processed message generated by the message generator, the message forwarding tool may make a query in the second forwarding table for the message processing manner corresponding to the message generated by the message generator, and perform message processing according to this message processing manner.

In the prior art, a message generated by a message generator is sent to a UPF (user plane function) network element of a Core Network, so that the UPF network element makes a query in a complex first forwarding table, and processes a to-be-processed message generated by the message generator according to a message processing manner obtained by query.

Compared with the prior art, when the system provided in the embodiments of the present application is used, the first user plane function network element generates the second forwarding table with the small data quantity according to the first forwarding table, and the message forwarding tool implements message processing by making a query in the second forwarding table with the small data quantity. On one hand, less CPU resources are consumed by making the query in the lightweight second forwarding table, thereby improving message processing performance, i.e., message forwarding efficiency. On the other hand, the generation of the second forwarding table and the query in the second forwarding table are respectively completed by the first user plane function network element and the message forwarding tool in the message processing system, that is, decoupling of the generation of the forwarding table and the query in the forwarding table is realized. After the decoupling, when a failure occurs in the first user plane function network element or the message forwarding tool separately, the normal operation of the other one will not be affected, which can avoid the situation that a message cannot be processed due to the failure of the first user plane function network element, and thus can improve the message forwarding efficiency.

### BRIEF DESCRIPTION OF DRAWINGS

To describe the technical solutions in embodiments of the present application or the prior art more clearly, the following briefly introduces the accompanying drawings required for describing the embodiments or the prior art. Apparently, the accompanying drawings in the following description are some embodiments of the present application, and a person of ordinary skill in the art can further obtain other drawings based on these accompanying drawings without creative efforts.

FIG. 1 is a schematic structural diagram of a message processing system provided in an embodiment of the present application.

FIG. 2 is a schematic diagram of a table structure of a second forwarding table provided in an embodiment of the present application.

FIG. 3 is a flow chart of a forwarding table query method provided in an embodiment of the present application.

FIG. 4 is a schematic structural diagram of another message processing system provided in an embodiment of the present application.

FIG. 5 is a schematic structural diagram of a communication system provided in an embodiment of the present application.

FIG. 6 is a schematic diagram of a table structure of another second forwarding table provided in an embodiment of the present application.

FIG. 7 is a flow chart of a message processing method provided in an embodiment of the present application.

FIG. 8 is a schematic diagram of a message processing method and a message processing system provided in an embodiment of the present application being applied in a live streaming scenario.

FIG. 9 is a schematic diagram of a message processing method and a message processing system provided in an embodiment of the present application being applied in a self-driving scenario.

FIG. 10 is a flow chart of another message processing method provided in an embodiment of the present application.

FIG. 11 is a schematic structural diagram of an electronic device provided in an embodiment of the present application.

FIG. 12 is a schematic structural diagram of another electronic device provided in an embodiment of the present application.

### DESCRIPTION OF EMBODIMENTS

To make the objectives, technical solutions, and advantages of embodiments of the present application clearer, the following clearly and completely describes the technical solutions in the embodiments of the present application with reference to the accompanying drawings in the embodiments of the present application. Apparently, the described embodiments are only a part rather than all of the embodiments of the present application. Based on the embodiments in the present application, all other embodiments obtained by those of ordinary skill in the art without making creative efforts shall fall within the protection scope of the present application.

The terms used in the embodiments of the present application are only for the purpose of describing specific embodiments, and are not intended to limit the present application. The singular forms of “a/an”, “the” and “said” used in the embodiments of the present application and the appended claims are also intended to include plural forms, unless the context clearly indicates other meanings, and the “plurality” generally includes at least two, but does not exclude the case of including at least one.

It should be understood that the term “and/or” used herein is merely an association relationship for describing associated objects, and indicates that three relationships may exist. For example, A and/or B may indicate three cases of A existing alone, A and B existing simultaneously, and B existing alone. In addition, the character “/” herein generally indicates that the associated objects before and after the character are in an “or” relationship.

Depending on the context, the words “if” and “in case” as used herein may be interpreted as “at the time of” or “when” or “in response to determining” or “in response to identifying”. Similarly, depending on the context, the phrase “if determining” or “if identifying (a condition or event stated)” may be interpreted as “when determining” or “in response to determining” or “when identifying (the condition or event stated)” or “in response to identifying (the condition or event stated)”.

It should also be noted that the terms “include”, “contain” or any other variant thereof are intended to cover non-exclusive inclusion, so that a commodity or system including a series of elements not only includes those elements, but also includes other elements not explicitly listed, or further includes elements inherent to such commodity or system. In the absence of more restrictions, an element defined by the sentence “including a/an . . . ” does not exclude the existence of other identical elements in a commodity or system including that element.

The following describes some embodiments of the present application in detail with reference to the accompanying drawings. In a case that there is no conflict between the embodiments, the following embodiments and features in the embodiments may be combined with each other. In addition, the step sequences in the following method embodiments are merely examples, and are not strictly limited.

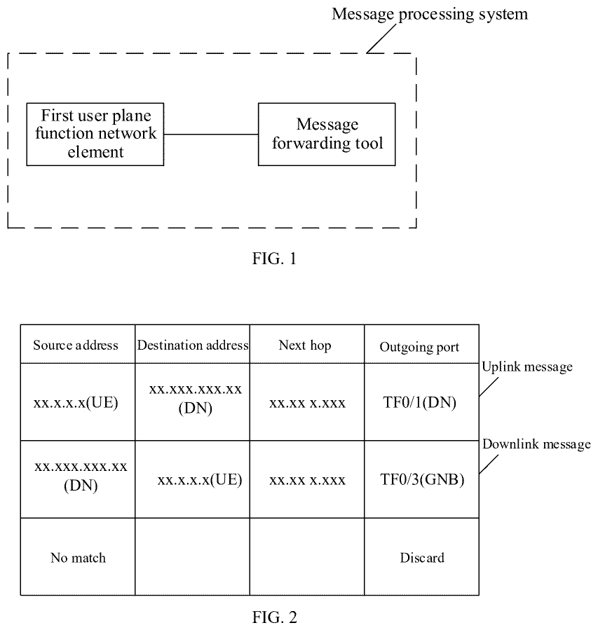

For ease of understanding, a message processing process may be described from the perspective of an entire message processing system. FIG. 1 is a schematic structural diagram of a message processing system provided in an embodiment of the present application. The system includes: a first user plane function network element and a message forwarding tool of a Core Network.

In order to simplify the subsequent description, the first user plane function (abbreviated as “UPF”) network element may be referred to as the first UPF network element.

A working process of the message processing system may be as follows. The first UPF network element may acquire a first forwarding table already configured on itself, and generate, according to the first forwarding table, a second forwarding table containing a correspondence between a message generator and a message processing manner. The first UPF network element may send the second forwarding table to the message forwarding tool by using a first communication protocol supported by both itself and the message forwarding tool. When receiving a to-be-processed message generated by the message generator, the message forwarding tool may make a query in the second forwarding table for the corresponding message processing manner according to identification information in the to-be-processed message, and process the to-be-processed message according to the message processing manner obtained by query. The message processing manner may specifically include message forwarding, message buffering, or message discarding.

In an implementation, the message generator may be a terminal device used by a user, or may be a server providing different services for a user.

The first forwarding table may include identification information of message generators and message forwarding rules. Here, the identification information may specifically include a network address corresponding to a message generator (i.e., a source address and a destination address of a to-be-processed message generated by the message generator), or a device serial number of a message generator and a destination address of a to-be-processed message, etc. The forwarding rules may specifically include packet detection rules (abbreviated as “PDR”) with different priorities and at least one rule respectively associated with each package detection rule, such as a forwarding action rule (abbreviated as “FAR”), a usage reporting rule (abbreviated as “URR”), a quality of service enforcement rule (QoS Enforcement Rule, abbreviated as “QER”), a buffering action rule (abbreviated as “BAR”), and so on.

Based on the foregoing contents contained in the first forwarding table, as for the generation of the second forwarding table, the first UPF network element may make a query in the forwarding rules in the first forwarding table by using the identification information of the message generator as a primary key, to obtain the corresponding message processing manner by query, thereby generating the second forwarding table containing the correspondence between the message generator and the message processing manner. Since the second forwarding table contains the correspondence between the message generator and the message processing manner, and does not contain a complex forwarding rule, the data quantity of the second forwarding table is less than that of the first forwarding table, and the second forwarding table is a lightweight forwarding table. In this way, the message forwarding tool consumes less CPU resources when making the query in the second forwarding table with the small data quantity, so as to improve message processing performance, i.e., message forwarding efficiency.

Meanwhile, the introduction of the message forwarding tool can realize decoupling of the generation process and the query process for the second forwarding table, and when failures occur in the message forwarding tool and the first UPF network element separately, the normal operation of the other one will not be affected, i.e., when the first UPF network element instance fails, the message forwarding tool can still use the second forwarding table, which is already configured, to process a message normally, thereby improving message forwarding availability.

In an implementation, the message forwarding tool may be in a software form, i.e. a second user plane function network element with a forwarding function, referred to as a second UPF network element. In an implementation, the message forwarding tool may also be in a hardware form, i.e., a forwarding device. In practice, the forwarding device may specifically be a field programmable gate array (abbreviated as “FPGA”) device, a processor, an intelligent switch or an intelligent network card, etc., and using the forwarding device in the hardware form can make the improvement of the message forwarding efficiency more significant.

Here, a table structure of the second forwarding table generated by the first UPF network element may be as shown in FIG. 2. This table structure is the same as a table structure supported by the forwarding device itself such as a network card, switch, etc. In FIG. 2, UE represents a terminal device, DN represents a server, and GNB represents a 5G base station. In FIG. 2, for the first row, since the second forwarding table includes a message outgoing port, the message forwarding tool is capable of forwarding the message generated by the terminal device or the server according to the outgoing port. In FIG. 2, for the third row, since a corresponding message processing manner is not obtained by query in the second forwarding table, the to-be-processed message will be discarded.

In the prior art, firstly a message generated by a message generator is received by a first UPF network element, and then the first UPF network element makes a query in a complex first forwarding table to obtain a message processing manner, and finally discards or forwards the message according to this manner. While in this embodiment, the first UPF network element can generate the second forwarding table with the small data quantity according to the first forwarding table, and the message forwarding tool implements message processing by making a query in the second forwarding table with the small data quantity. On one hand, less CPU resources are consumed by making the query in the lightweight second forwarding table, which ensures message forwarding efficiency. On the other hand, the generation of the second forwarding table and the query in the second forwarding table are respectively completed by the first UPF network element and the message forwarding tool in the message processing system, that is, decoupling of the generation of the forwarding table and the query in the forwarding table is realized, and when the first UPF network element fails, the normal processing for the massage by the message forwarding tool will not be affected, which can improve the message forwarding efficiency.

According to the embodiment shown in FIG. 1, it can be seen that the message forwarding tool, whether in a software form or in a hardware form, may obtain the message processing manner corresponding to the to-be-processed message by making the query in the lightweight second forwarding table. The following cases may occur during a forwarding table query process.

In a case, as described in the embodiment shown in FIG. 1, if the message forwarding tool can obtain the corresponding message processing manner by query from the second forwarding table according to the identification information (e.g., a source address and a destination address of the message) of the message generator contained in the to-be-processed message, the message forwarding tool may forward or discard the to-be-processed message according to the message processing manner obtained by query.

In another case, if the message forwarding tool does not obtain the corresponding message processing manner by query in the second forwarding table according to the identification information in the to-be-processed message, the message forwarding tool may send the to-be-processed message to the first UPF network element by using a first communication protocol supported by both the message forwarding tool and the first UPF network element, to enable the first UPF network element to make a further query in the first forwarding table. If the first UPF network element obtains the message processing manner corresponding to the to-be-processed message by query in the first forwarding table, the to-be-processed message may be processed according to the message processing manner obtained by query. If the first UPF network element does not obtain the message processing manner corresponding to the to-be-processed message by query in the first forwarding table, the to-be-processed message is discarded.

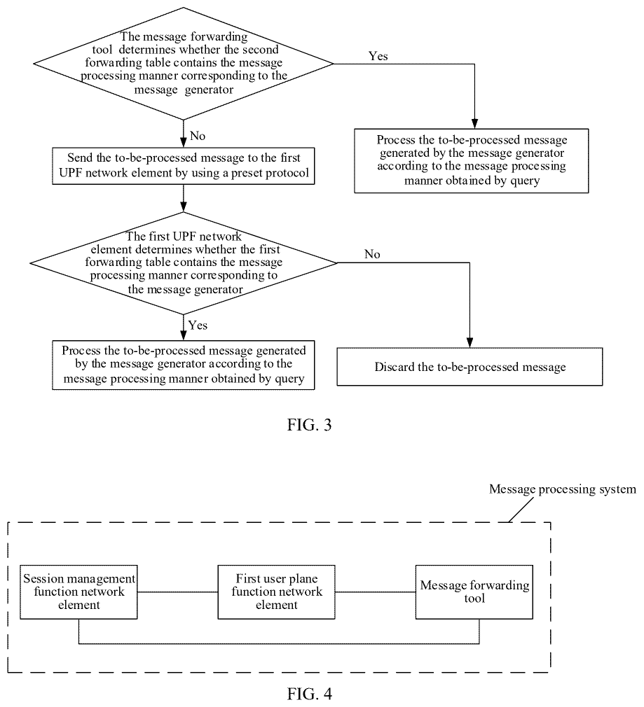

The above process of performing multi-stage query by using different forwarding tables in different cases can also be understood in conjunction with the flow chart shown in FIG. 3.

It should also be noted that, since the second forwarding table is generated according to the first forwarding table, generally, if the message forwarding tool cannot obtain the message processing manner of the to-be-processed message by query from the second forwarding table, the first UPF network element cannot obtain the message processing manner of the to-be-processed message by query from the first forwarding table either, and the to-be-processed message will be discarded eventually.

However, in practice, compared with the first forwarding table, the correspondence contained in the second forwarding table may lag behind, that is, after the first forwarding table is updated, the correspondence between the message generator and the message processing manner contained in updated contents is not updated to the second forwarding table in time. Due to such lag, it is possible for such a situation to occur that although the message processing manner corresponding to the to-be-processed message is not obtained by query in the second forwarding table, the message processing manner corresponding to the to-be-processed message may be obtained by query in the first forwarding table. Therefore, using the multi-stage query manner shown in FIG. 3 can improve correctness of message processing.

In practice, in an actual processing process for the to-be-processed message, in an implementation, in order to improve the forwarding efficiency and simplify the query process, if the message forwarding tool does not obtain the corresponding message processing manner by query in the second forwarding table according to the identification information in the to-be-processed message, the to-be-processed message may also be directly discarded.

In an implementation, in order to improve accuracy of message forwarding, when the message processing manner corresponding the to-be-processed message is not obtained by query in both the first forwarding table and the second forwarding table, the query may also continue to be made in the first forwarding table. If the message processing manner corresponding to the to-be-processed message is still not obtained by query after making the query in the first forwarding table for a preset number of times, the to-be-processed message is discarded.

In a process of receiving and processing messages normally by using the message processing system shown in FIG. 1, other network elements in a 5G Core Network also need to be used. FIG. 4 is a schematic structural diagram of another message processing system provided in an embodiment of the present application. On the basis of the system shown in FIG. 1, this system may further include: a session management function (abbreviated as “SMF”) network element of a Core Network.

The SMF network element may establish a session connection between a message generator and a first UPF network element, and in a process of establishing the session connection, the first UPF network element is capable of obtaining various contents in a first forwarding table sent by the SMF network element. According to the embodiment shown in FIG. 1, it can also be seen that the first UPF network element may make a query in forwarding rules in the first forwarding table by using identification information of the message generator as a primary key, to generate a second forwarding table. Acquisition of the identification information also needs the help of a session establishment function of the SMF network element.

In an acquisition manner, the SMF network element may receive and forward a session connection request sent by the message generator to the first UFP network element, to establish the session connection between the first UPF network element and the message generator. In this case, the first UPF network element may acquire the identification information of the message generator in the session establishment request, in response to the establishment of the session connection. Here, the foregoing establishment process of the session connection may be considered as a process of registering the message generator into the first UPF network element. Although the first UPF network element does not directly receive a to-be-processed message generated by a message generator, since the first UPF network element needs to generate the second forwarding table according to the first forwarding table, only after registration can the second forwarding table contain a correspondence between the message generator and a message processing manner, to enable a message forwarding tool to process the to-be-processed message generated by the registered message generator normally.

According to the foregoing acquisition manner, the first UPF network element can obtain the identification information and generate the second forwarding table before the to-be-processed message is generated. When the to-be-processed message is generated, the message forwarding tool can directly make a query in the second forwarding table, thereby improving the processing speed for the to-be-processed message.

In another acquisition manner, after the session connection between the message generator and the first UPF network element is established by the SMF network element, and after a to-be-processed message generated by the message generator for the first time, i.e., a target message, is received by a message forwarding tool, the message forwarding tool may forward the target message to the first UPF network element by using a first communication protocol. At this time, the first UPF network element may acquire the identification information of the message generator contained in the target message.

According to the foregoing manner, in response to the first-time generation of the to-be-processed message, the first UPF network element may obtain the identification information and generate the second forwarding table. A query will be immediately made in the second forwarding table by the message forwarding tool, and the to-be-processed message is forwarded or discarded according to a query result, which can ensure the usage rate of the second forwarding table.

Here, it should be noted that, when the message forwarding tool is specifically a second UPF network element in a software form, in order to ensure that the to-be-processed message generated by the message generator can be received by the second UPF network element, the SMF network element in the message processing system is further configured to establish a session connection between the message generator and the second UPF network element.

In an implementation, the message forwarding tool may further perform traffic statistics, i.e., perform statistics on a total quantity of to-be-processed messages received by the message forwarding tool within a preset time period, and a traffic statistics result may be reported to the first UPF network element.

In an implementation, the message forwarding tool may further perform statistics on a cumulative quantity of to-be-processed messages that fail to be forwarded within a preset time period, and send the cumulative quantity to the first UPF network element. When the cumulative quantity reaches a preset quantity, which indicates that a forwarding rule in the second forwarding table is unreasonable, then the first UPF network element may generate a prompt message. The message generator can know that the forwarding rule is unreasonable through this prompt message, and it is further determined by an operation-maintenance staff of the message generator whether the forwarding rule needs to be modified.

In the embodiment, with the help of the session connection establishment function of the SMF network element of the Core Network, the first UPF network element can acquire the identification information of the message generator, and generate the second forwarding table according to the identification information. Here, an acquisition timing of the identification information, i.e., a generation timing of the second forwarding table, may be after the session connection is established, which can improve the message processing speed. The acquisition timing of the identification information, i.e., the generation timing of the second forwarding table, may also be after the message forwarding tool receives the target message, which can improve the usage rate of the forwarding table. In addition, contents not described in detail and achievable technical effects in this embodiment may be found in related descriptions in the foregoing embodiments, which will not be described here again.

The foregoing embodiments focus on describing the process of processing the to-be-processed message by the message forwarding tool. However, the message forwarding tool is not an end of message processing, and a complete message processing process may further be implemented with the help of a communication system. FIG. 5 is a schematic structural diagram of a communication system provided in an embodiment of the present application. The system may include: a terminal device, a 5G base station, a message processing subsystem and a server. The message processing subsystem specifically includes a message forwarding tool, a first UPF network element of a Core Network and an SMF network element of the Core Network.

The 5G base station and the message forwarding tool in the system may support a second communication protocol, thus a to-be-processed message transmitted between the two needs to be applicable to the second communication protocol, i.e., the to-be-processed message transmitted between the two needs to contain a message header corresponding to the second communication protocol. However, a to-be-processed message transmitted between other devices in the communication system does not need to contain the message header corresponding to the second communication protocol. In an implementation, the second communication protocol may be a GPRS (General Packet Radio Service) tunneling protocol (abbreviated as “GTP”) or any communication protocol supported by the 5G base station and the message forwarding tool. Therefore, after the message forwarding tool receives a to-be-processed message generated by a message generator, the message forwarding tool further needs to perform a corresponding operation on the to-be-processed message according to different transmission directions of to-be-processed messages before forwarding or discarding the to-be-processed message. A manner of the operation may include adding the message header of the second communication protocol, i.e., message encapsulation, or removing the message header of the second communication protocol, i.e., message decapsulation. It should also be noted that, when the message forwarding tool may be presented in a hardware form such as a network card or a switch, the message forwarding tool needs to be an intelligent network card or an intelligent switch supporting the protocol GTP. In the following, the protocol GTP is used as examples for description.

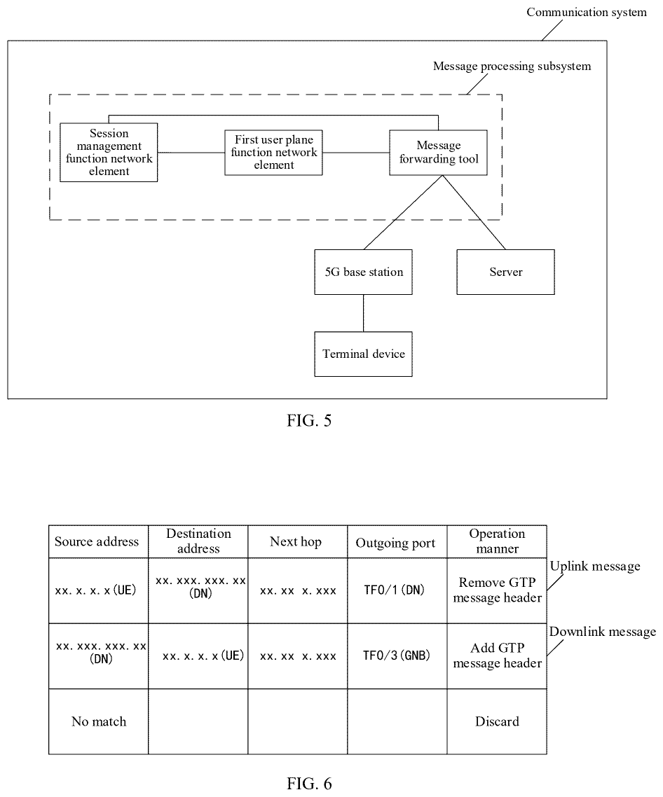

An overall working process of the message processing subsystem in the system is similar to the embodiment shown in FIG. 4. The first UPF network element in the message processing subsystem may generate a second forwarding table according to a first forwarding table, and the second forwarding table includes a correspondence between a message generator and a message processing manner. However, since a message transmission between the 5G base station and the message forwarding tool needs to use the protocol GTP, different from the foregoing embodiment, the message processing manner in the second forwarding table includes a message sending manner and a message operation manner. The message sending manner specifically includes forwarding or discarding; and the message operation manner specifically includes adding a GTP message header and removing a GTP message header. A correspondence between the message generator and the message operation manner may specifically be: if the message generator is the terminal device, the message operation manner is removing the GTP message header; if the message generator is the server, the message operation manner is adding the GTP message header. In this embodiment, a table structure of the second forwarding table may be as shown in FIG. 6. Compared with the table structure shown in FIG. 2, a field of a message operation manner is added. A process of generating the second forwarding table may be found in related descriptions in the foregoing embodiments, which will not be described here again.

Then, based on the foregoing description, a complete process of processing, by the communication system, an uplink message generated by the terminal device may be as follows.

An initial message generated by the terminal device may be sent to the 5G base station, and the 5G base station may add the GTP message header to the initial message by using the protocol GTP supported by itself, to obtain an uplink message, and further send the uplink message to the message forwarding tool. The message forwarding tool may acquire identification information of the terminal device by parsing the GTP message header in the uplink message, and obtain by query from the second forwarding table according to the identification information that the message sending manner corresponding to the uplink message is message forwarding, and that the message operation manner corresponding to the uplink message is removing the GTP message header. Finally, the message forwarding tool may remove the GTP message header to restore and obtain the initial message generated by the terminal device, and send the initial message to the server.

Similarly, a complete process of processing, by the communication system, an initial message generated by the server may be as follows.

An initial message generated by the server may be sent to the message forwarding tool, and the message forwarding tool may obtain by query from the second forwarding table according to identification information (e.g., a destination address of the initial message) of the server that the sending manner corresponding to the initial message is message forwarding, and that the operation manner corresponding to the initial message is adding the GTP message header. Further, the message forwarding tool may take the initial message after being added with the GTP message header as a downlink message and forward it to the 5G base station. After receiving the downlink message containing the GTP message header, the 5G base station may remove the GTP message header of the downlink message by using the protocol GTP supported by itself, to restore and obtain the initial message generated by the server, and send the initial message to the terminal device.

In the embodiment, when the to-be-processed message generated by the message generator is transmitted between the 5G base station and the message forwarding tool based on the protocol GTP, the message forwarding tool may obtain a corresponding message sending manner and a corresponding message operation manner by query in the second forwarding table, and process the to-be-processed message according to the contents obtained by query. In addition, contents not described in detail and achievable technical effects in this embodiment may be found in related descriptions in the foregoing embodiments, which will not be described here again.

It should be noted here that the to-be-processed message, which is generated by the message generator and needs to be processed by the message forwarding tool, mentioned in the foregoing embodiments may be, more precisely, the uplink message or downlink message containing the message header in the embodiment shown in FIG. 5. In addition, it has been described in the foregoing embodiment that, for the uplink message or downlink message generated by the message generator, the message forwarding tool may process it by means of making a query in the second forwarding table, and the specific process may be like the flow chart shown in FIG. 3.

However, in practice, for the uplink message and the downlink message received by the message forwarding tool, if the message forwarding tool has a buffering function, the message forwarding tool may directly buffer the uplink message or downlink message locally, waiting for the message forwarding tool to further forward it.

If the message forwarding tool does not have a buffering function, for a received uplink message or a received downlink message which cannot be processed immediately, the message forwarding tool may report the uplink message or the downlink message to the first UPF network element by using a first communication protocol supported by itself and the first UPF network element, to enable the first UPF network element to process the uplink message or the downlink message by making a query in the first forwarding table, thereby ensuring correct processing of the to-be-processed message.

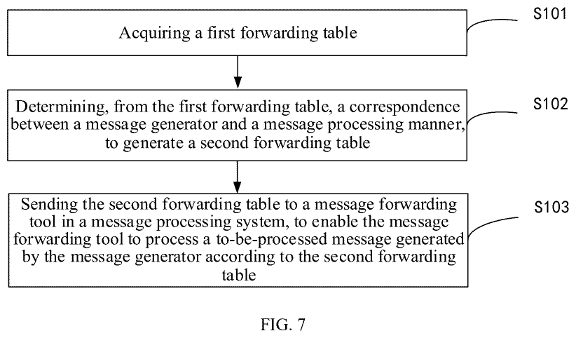

The message processing process is described from a perspective of a system in the foregoing embodiments, and may also be described below from a perspective of a first UPF network element. FIG. 7 is a flow chart of a message processing method provided in an embodiment of the present application. The method may be performed by a first UPF network element in a message processing system. As shown in FIG. 7, the method may include the following steps.

S101, acquiring a first forwarding table.

S102, determining, from the first forwarding table, a correspondence between a message generator and a message processing manner, to generate a second forwarding table.

S103, sending the second forwarding table to a message forwarding tool in the message processing system, to enable the message forwarding tool to process a to-be-processed message generated by the message generator according to the second forwarding table.

In a process of establishing a session connection between the message generator and the first UPF network element, an SMF network element may send various forwarding rules to the first UPF network element, to enable the first UPF network element to obtain the first forwarding table. Next, the first UPF network element determines, according to identification information of the message generator, the correspondence between the message generator and the message processing manner from the first forwarding table, and generates the second forwarding table containing the correspondence. Finally, the first UPF network element sends the second forwarding table to the message forwarding tool, to enable the message forwarding tool to process the to-be-processed message generated by the message generator according to the second forwarding table.

In an implementation, the message forwarding tool may be a forwarding device in a hardware form, such as a processor, an FPGA, an intelligent network card, an intelligent switch, or the like, or may be a second UPF network element in a software form.

In an implementation, for an acquisition timing of the identification information of the message generator, it may be when the SMF network element establishes the session connection between the first UPF network element and the message generator, or may be when the message forwarding tool receives a to-be-processed message generated by the message generator for the first time after establishing the session connection.

Here, contents not described in detail in this embodiment may be found in related descriptions in the embodiment shown in FIG. 1, which will not be described here again.

In the embodiment, firstly the first UPF network element acquires the first forwarding table, and determines from it the correspondence between the message generator and the message processing manner, to generate the second forwarding table. Then the first UPF network element sends the second forwarding table to the message forwarding tool in the message processing system, and the message processing tool makes a query in the second forwarding table for the message processing manner corresponding to the to-be-processed message generated by a sender, and performs message processing according to this message processing manner.

Compared with the prior art, where a message generated by a message generator is sent to a UPF network element of a Core Network, and the UPF network element firstly makes a query in a first forwarding table to obtain a message processing manner and then discards or forwards the message according to this manner, by using the method provided in the embodiment of the present application, the second forwarding table is obtained according to the first forwarding table, therefore the data quantity of the second forwarding table is less than that of the first forwarding table, so that the message forwarding tool consumes less CPU resources in a process of making the query in the second forwarding table and processing the message, which ensures the message processing speed. In addition, the generation of the forwarding table is completed by the user plane function network element in the message processing system, and the processing of the message is completed by the message forwarding tool in the system, that is, decoupling of the generation of the forwarding table and the query in the forwarding table is realized, and when a failure occurs in the user plane function network element or the message forwarding tool separately, the normal operation of the other one will not be affected, which can avoid the situation that a message cannot be processed due to the failure of the first user plane function network element.

In an implementation, a table structure of the second forwarding table generated by the first UPF in the embodiment shown in FIG. 7 may be as shown in FIG. 2 or FIG. 6, and the message forwarding tool may forward the to-be-processed message according to the manners provided in the embodiments shown in FIG. 1 to FIG. 6. Achievable technical effects may also be found in related descriptions in the foregoing embodiments, which will not be described here again.

In the foregoing system and method embodiments, the to-be-processed message of the message generator may be for different services, such as the services provided by the various APPs or the self-driving service mentioned in the Background, and so on.

When the message generator is a terminal device, and the terminal device is installed with a live streaming APP for providing a live streaming service, an initial message generated by the terminal device may be a request message for requesting live streaming data. When the message generator is a live streaming server for storing live streaming data, a body of an initial message generated by the live streaming server includes the live streaming data.

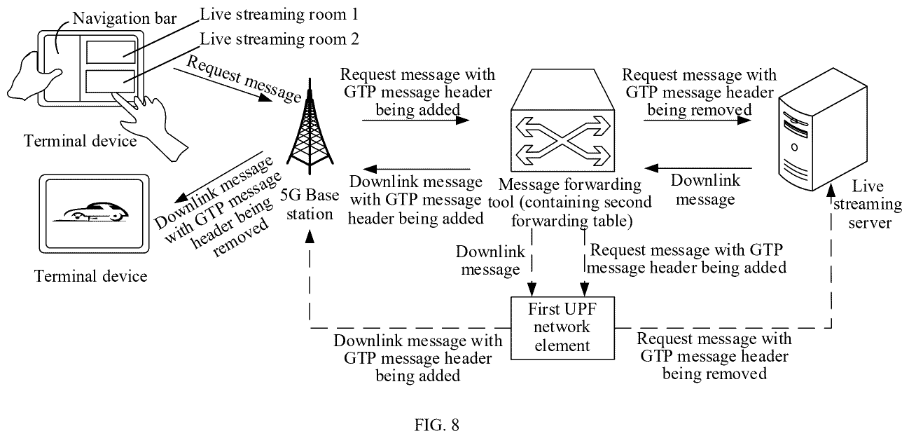

For ease of understanding, a specific implementation process for the above-provided message processing systems and methods may be exemplarily described in conjunction with a live streaming scenario. The following process can be understood with reference to FIG. 8.

A data uplink stage: a user may start a live streaming APP installed in a terminal device and select a live streaming room 2 to enter. At this time, in response to an entering operation for the live streaming room 2, the terminal device may generate and send a request message to a 5G base station. The 5G base station may add a GTP message header to the request message according to a protocol GTP supported by itself, to obtain an uplink message, and further send the uplink message to a message forwarding tool.

Then, the message forwarding tool may parse the GTP message header in the uplink message to obtain a source address of the uplink message, i.e., a network address of the terminal device, and a destination address of the uplink message, i.e., a network address of a live streaming server, and obtain by query from a second forwarding table according to the source address that a message sending manner corresponding to the uplink message is forwarding, and a message operation manner corresponding to that is removing the GTP message header added by the 5G base station. Here, a process of generating the second forwarding table may be found in related descriptions in the foregoing embodiments, which will not be described here again.

Finally, the message forwarding tool may remove the GTP message header in the uplink message to restore and obtain the request message generated by the terminal device, and send the request message to the live streaming server.

A data downlink stage: the live streaming server responds to the request message generated by the terminal device, and generates an initial message containing live streaming data of the live streaming room 2, where the live streaming data is the body of the initial message. The live streaming server may send the initial message generated by itself to the message forwarding tool.

Then, the message forwarding tool may directly obtain by query from the second forwarding table according to a destination address included in the initial message, i.e., the network address of the terminal device, that a message sending manner corresponding to the initial message is forwarding, and a message operation manner corresponding to that is adding a GTP message header.

Finally, the message forwarding tool may add the GTP message header to the initial message to obtain a downlink message, and send the downlink message to the 5G base station. The 5G base station then removes the GTP message header of the downlink message, and sends it to the terminal device according to the destination address of the downlink message. At this time, the user can watch a live streaming video.

In an implementation, the live streaming video watched by the user may be a live streaming video of a sports event or a game, or may be a live streaming video for realizing remote education or remote medical treatment.

In an implementation, in the foregoing data uplink and data downlink stages, if the message forwarding tool cannot obtain the message sending manner and the message operation manner corresponding to the message by query according to the second forwarding table deployed on itself, the message forwarding tool may further send the message to a first UPF network element, to enable the first UPF network element to make a query in a first forwarding table deployed on itself, and to perform message processing according to the query, thereby ensuring correct processing of the message. This is just as the process shown with dotted lines in FIG. 8.

When the message generator is a vehicle in a self-driving mode, the vehicle generates an initial message, where the initial message is a request message for requesting path planning data. When the message generator is a server that receives travelling data collected by a vehicle and performs path planning, a body of an initial message generated by the server includes path planning data.

It is similar to the above live streaming scenario. A data uplink stage: when a vehicle is in a self-driving mode, it may generate a request message, and position data of the vehicle may be contained as the body in the request message. After the request message is transmitted to a 5G base station, the 5G base station will add a GTP message header to it to obtain an uplink message, and send the uplink message containing the GTP message header to a message forwarding tool. Then, the message forwarding tool may parse the GTP message header in the uplink message to obtain a source address of the uplink message, i.e., a network address of the vehicle, and a destination address of the uplink message, i.e., a network address of a server, and obtain by query from a second forwarding table according to the source address that a message sending manner corresponding to the message is forwarding, and a message operation manner corresponding to that is removing the GTP message header added by the 5G base station. Finally, the message forwarding tool may remove the GTP message header in the uplink message to restore and obtain the initial message, and send it to the server.

A data downlink stage: the server responds to the request message, and generates and sends an initial message containing path planning data to the message forwarding tool. Then, the message forwarding tool may obtain by query from the second forwarding table according to a destination address included in the initial message generated by the server, i.e., the network address of the vehicle, that a message sending manner corresponding to the initial message is forwarding, and a message operation manner corresponding to that is adding a GTP message header.

Finally, the message forwarding tool may add the GTP message header to the initial message to obtain a downlink message, and send the downlink message to the 5G base station. The 5G base station then removes the GTP header of the downlink message, to restore and obtain the initial message generated by the server, and sends it to the vehicle according to the destination address of the initial message. At this time, the vehicle can perform self-driving according to navigation data in the initial message.

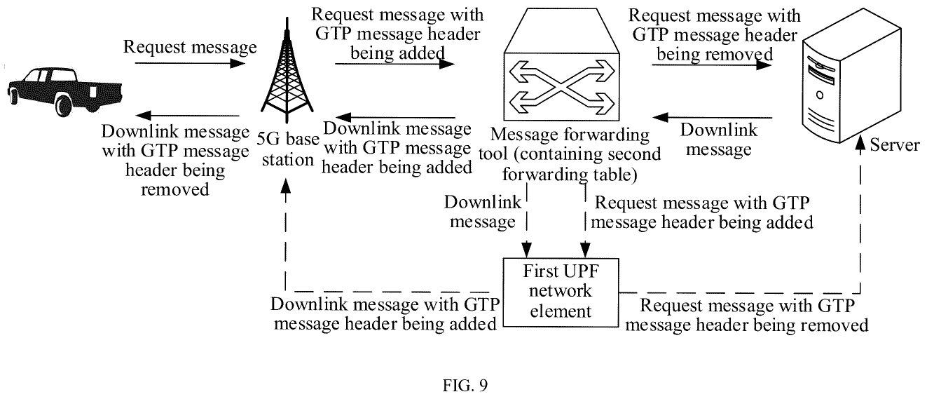

In the foregoing self-driving scenario, processing processes for the uplink message and the downlink message can also be understood with reference to FIG. 9.

All of the foregoing embodiments are the process of processing the to-be-processed message generated by the message generator through the message forwarding tool independent of the first UPF network element, and the message forwarding efficiency is improved in the two aspects of decoupling the generation process and the query process for the second forwarding table, and reducing the data quantity in the forwarding table. In practice, in an implementation, using a lightweight second forwarding table can also improve the message forwarding efficiency to a certain extent.

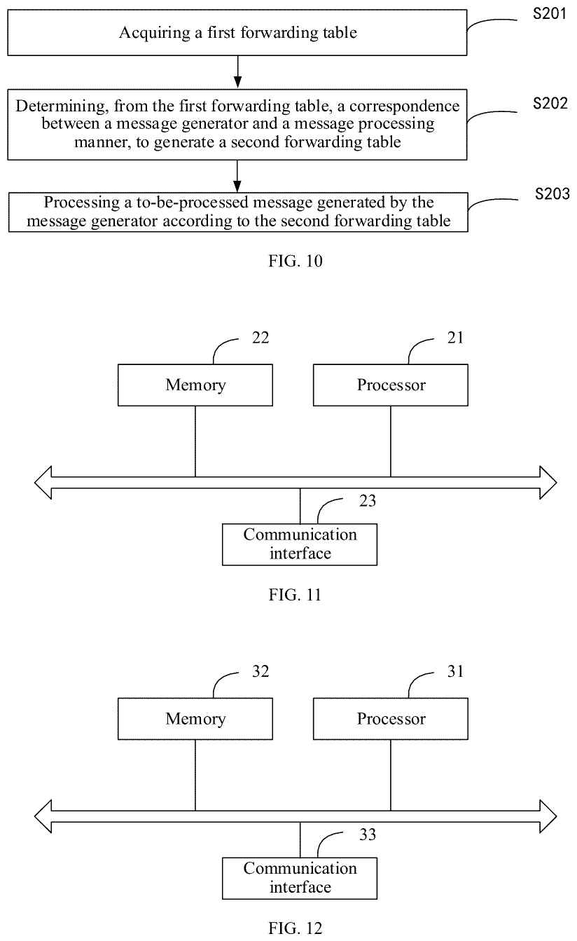

FIG. 10 is a flow chart of another message processing method provided in an embodiment of the present application. The method may be performed by a first UPF network element in a message processing system. As shown in FIG. 10, the method may include the following steps.

S201, acquiring a first forwarding table.

S202, determining, from the first forwarding table, a correspondence between a message generator and a message processing manner, to generate a second forwarding table.

S203, processing a to-be-processed message generated by the message generator according to the second forwarding table.

In a process in which an SMF network element establishes a session connection between the first UPF network element and the message generator, the SMF network element may send various forwarding rules to the first UPF network element, to enable the first UPF network element to obtain the first forwarding table containing the various forwarding rules. Then, the second forwarding table is generated according to the first forwarding table, and the second forwarding table is deployed inside the first UPF network element. The first UPF network element may make a query in the lightweight second forwarding table to obtain the message processing manner corresponding to the to-be-processed message generated by the message generator, and process the message according to this manner. Here, according to different table structures of second forwarding tables, the message processing manner may specifically include a message sending manner, or a message sending manner and a message operation manner.

In an implementation, similar to the flow chart shown in FIG. 3, when the corresponding message processing manner is not obtained by query in the second forwarding table, a query in the first forwarding table may be further made, and a message processing manner is obtained by query from the first forwarding table.

Contents not described in detail in this embodiment may also be found in related descriptions in the foregoing embodiments, which will not be described here again.

Compared with the embodiments shown in FIG. 1 to FIG. 9, the first UPF network element further has the message processing capability of the message forwarding tool in the above embodiments while having the capability of generating the second forwarding table.

In the embodiment, the first UPF network element firstly acquires the first forwarding table, determines from it the correspondence between the message generator and the message processing manner to generate the second forwarding table, and then processes the to-be-processed message generated by the message generator according to the second forwarding table.

Compared with the prior art, where a UPF network element directly makes a query in a complex first forwarding table to determine discarding or forwarding a to-be-processed message generated by a message generator, in this embodiment, the second forwarding table is obtained according to the first forwarding table, therefore the data quantity of the second forwarding table is less than that of the first forwarding table. Then, the first UPF network element directly makes the query in the lightweight second forwarding table, so that less CPU resources are consumed in the query process, which ensures the message processing speed, i.e., improves the message forwarding efficiency.

In addition, the message processing method provided in FIG. 10 can also be applied to the live streaming and self-driving scenarios shown in FIG. 8 and FIG. 9. The specific processes will not be repeated.

In a possible design, the message processing method provided in the foregoing embodiments may be applied to an electronic device. As shown in FIG. 11, the electronic device may include a processor 21 and a memory 22. Here, the memory 22 is configured to store a program that supports the electronic device to perform the message processing method provided in the above embodiments shown in FIG. 1 to FIG. 9, and the processor 21 is configured to execute the program stored in the memory 22.

The program includes one or more computer instructions, where when the one or more computer instructions are executed by the processor 21, the following steps are enabled to implement:
acquiring a first forwarding table; determining, from the first forwarding table, a correspondence between a message generator and a message processing manner, to generate a second forwarding table; sending the second forwarding table to a message forwarding tool in a message processing system, to enable the message forwarding tool to process a to-be-processed message generated by the message generator according to the second forwarding table.

In an implementation, the processor 21 is further configured to perform all or a part of the steps in the forgoing embodiments shown in FIG. 1 to FIG. 9.

Here, a structure of the electronic device may further include a communication interface 23, configured for the electronic device to communicate with other devices or a communication network.

In a possible design, the message processing method provided in the foregoing embodiments may be applied to an electronic device. As shown in FIG. 12, the electronic device may include a processor 31 and a memory 32. Here, the memory 32 is configured to store a program that supports the electronic device to perform the message processing method provided in the above embodiment shown in FIG. 10, and the processor 31 is configured to execute the program stored in the memory 32.

The program includes one or more computer instructions, where when the one or more computer instructions are executed by the processor 31, the following steps are enabled to implement:
acquiring a first forwarding table; determining, from the first forwarding table, a correspondence between a message generator and a message processing manner, to generate a second forwarding table; processing a to-be-processed message generated by the message generator according to the second forwarding table.

In an implementation, the processor 31 is further configured to perform all or a part of the steps in the forgoing embodiment shown in FIG. 10.

Here, a structure of the electronic device may further include a communication interface 33, configured for the electronic device to communicate with other devices or a communication network.

In addition, an embodiment of the present application provides a computer storage medium, configured to store computer software instructions used by the above-mentioned electronic devices, for performing the program involved in the message processing method in the above method embodiments shown in FIG. 1 to FIG. 10.

An embodiment of the present application further provides a computer program product including computer instructions, where the computer instructions instruct a computing device to perform operations corresponding to any one of the foregoing multiple method embodiments.

Finally, it should be noted that the above embodiments are only used to illustrate the technical solutions of the present application, but not to limit them. Although the present application has been described in detail with reference to the foregoing embodiments, those of ordinary skill in the art should understand that the technical solutions recorded in the foregoing embodiments may still be modified, or some technical features thereof may be equivalently replaced; and these modifications or replacements do not make essence of a corresponding technical solution depart from the spirit and scope of the technical solutions of the embodiments of the present application.

1. A message processing system, comprising: a first user plane function network element and a message forwarding tool of a Core Network;
the first user plane function network element is configured to:
acquire a first forwarding table;
determine, from the first forwarding table, a correspondence between a message generator and a message processing manner, to generate a second forwarding table;
send the second forwarding table to the message forwarding tool;
the message forwarding tool is configured to:
receive a to-be-processed message sent by the message generator;
process the to-be-processed message according to the second forwarding table.

2. The system according to claim 1, wherein the message forwarding tool comprises a forwarding device or a second user plane function network element with a forwarding function.

3. The system according to claim 1, wherein the message forwarding tool is configured to: if the second forwarding table does not comprise a message processing manner corresponding to the to-be-processed message, send the to-be-processed message to the first user plane function network element according to a first communication protocol supported by both the message forwarding tool and the first user plane function network element;
the first user plane function network element is configured to: process the to-be-processed message according to the first forwarding table.

4. The system according to claim 1, wherein the message forwarding tool is further configured to: perform statistics on a cumulative quantity of to-be-processed messages that fail to be forwarded within a preset time period; send the cumulative quantity to the first user plane function network element.

5. The system according to claim 4, wherein the first user plane function network element is configured to: if the cumulative quantity reaches a preset quantity, generate a prompt message reflecting forwarding failures of the to-be-processed messages, and send the prompt message to the message generator.

6. The system according to claim 1, wherein the first user plane function network element is configured to:
acquire identification information of the message generator;
make, according to the identification information, a query for a message processing manner corresponding to the message generator of the identification information from forwarding rules comprised in the first forwarding table;
determine the correspondence between the message generator and the message processing manner, to generate the second forwarding table.

7. The system according to claim 6, wherein the first user plane function network element is configured to:
acquire the identification information in response to establishment of a session connection between the message generator and the first user plane function network element; or
acquire the identification information in response to the message forwarding tool receiving a target message, wherein the target message is a to-be-processed message sent by the message generator for a first time after establishment of a session connection between the message generator and the first user plane function network element.

8. The system according to claim 1, wherein the message forwarding tool and a base station support a second communication protocol, and the to-be-processed message is an uplink message obtained by the base station encapsulating a received message according to the second communication protocol;
the message forwarding tool is configured to:
receive the uplink message forwarded by the base station;
parse the uplink message forwarded by the base station according to the second communication protocol to obtain identification information of the message generator;
process the uplink message according to the identification information and the second forwarding table.

9. A message processing method, applied to a first user plane function network element in a message processing system, wherein the method comprises:
acquiring a first forwarding table;
determining, from the first forwarding table, a correspondence between a message generator and a message processing manner, to generate a second forwarding table;
sending the second forwarding table to a message forwarding tool in the message processing system, to enable the message forwarding tool to process a to-be-processed message generated by the message generator according to the second forwarding table.

10. The method according to claim 9, wherein the message forwarding tool comprises a forwarding device in the message processing system or a second user plane function network element with a forwarding function in the message processing system.

11. The method according to claim 9, wherein the method further comprises:
receiving a to-be-processed message which is sent by the message forwarding tool and is unprocessed, wherein the message forwarding tool sends the to-be-processed message which is unprocessed by using a first communication protocol supported by both the message forwarding tool and the first user plane function network element;
process the to-be-processed message according to the first forwarding table.

12. A message processing method, applied to a user plane function network element of a Core Network, wherein the method comprises:
acquiring a first forwarding table;
determining, from the first forwarding table, a correspondence between a message generator and a message processing manner, to generate a second forwarding table;
processing, according to the second forwarding table, a to-be-processed message generated by the message generator.

13. An electronic device, comprising: a memory and a processor, wherein the memory stores executable code, and when the executable code is executed by the processor, the processor is caused to perform the message processing method according to claim 9.

14. A non-transitory machine-readable storage medium, wherein the non-transitory machine-readable storage medium stores executable code, and when the executable code is executed by a processor of an electronic device, the processor is caused to perform the message processing method according to claim 9.

15. (canceled)

16. The method according to claim 9, further comprising:
receiving, from the message forwarding tool, a cumulative quantity of to-be-processed messages that fail to be forwarded within a preset time period;
wherein the cumulative quantity is obtained, by the message forwarding tool, through performing statistics on the to-be-processed messages that fail to be forwarded within the preset time period.

17. The method according to claim 16, wherein if the cumulative quantity reaches a preset quantity, generating a prompt message reflecting forwarding failures of the to-be-processed messages, and sending the prompt message to the message generator.

18. The method according to claim 9, wherein determining, from the first forwarding table, the correspondence between the message generator and the message processing manner, to generate the second forwarding table comprises:
acquiring identification information of the message generator;
making, according to the identification information, a query for a message processing manner corresponding to the message generator of the identification information from forwarding rules comprised in the first forwarding table;
determining the correspondence between the message generator and the message processing manner, to generate the second forwarding table.

19. The method according to claim 18, comprising:
acquiring the identification information in response to establishment of a session connection between the message generator and the first user plane function network element; or
acquiring the identification information in response to the message forwarding tool receiving a target message, wherein the target message is a to-be-processed message sent by the message generator for a first time after establishment of a session connection between the message generator and the first user plane function network element.

20. An electronic device, comprising: a memory and a processor, wherein the memory is configured to store one or more computer instructions, and when the one or more computer instructions are executed by the processor, the processor is caused to perform the message processing method according to claim 12.

21. A non-transitory machine-readable storage medium, wherein the non-transitory machine-readable storage medium stores executable code, and when the executable code is executed by a processor of an electronic device, the processor is caused to perform the message processing method according to claim 12.
